(19) United States
(12) Patent Application Publication
(10) Pub. No.: US 2007/0228793 A1
(43) Pub. Date: Oct. 4, 2007

(54) THEFT PROTECTION CHAIR STRUCTURE FOR MOTOR VEHICLES

(76) Inventors: Kang-Hua Chao, Danshuei Township (TW); Shinka Naka, Osaka (JP)

Correspondence Address: PAI PATENT & TRADEMARK LAW FIRM, 1001 FOURTH AVENUE, SUITE 3200, SEATTLE, WA, 98154, US

(21) Appl. No.: 11/469,379

(22) Filed: Aug. 31, 2006

(30) Foreign Application Priority Data
Mar. 31, 2006 (TW) 95205498

(51) Int. Cl. B60N 2/02

(52) U.S. Cl. 297/353

(57) ABSTRACT

A theft protection chair structure for motor vehicles for minimizing the driving space for the driver, includes: a chair having a chair seat and a chair back connected to the chair seat by a pin-jointed structure; a chair driving structure for driving the chair to go forward or backwards toward the driving space, to form a theft protection or a sitting state; and an angular adjustment device for adjusting the slant angle between the chair back and chair seat. When the chair driving structure is in a theft protection state, the angular adjustment device enables the angle between the chair back and chair seat to be an acute angle, then be locked and fixed. Thus, the theft protection effect is provided via the angular adjustment device and chair driving structure to reduce the driving space.

### RELATED APPLICATIONS

The present application is based on, and claims priority from, Taiwan Application Serial Number 95205498, filed Mar. 31, 2006, the disclosure of which is hereby incorporated by reference herein in its entirety.

### FIELD OF THE INVENTION

The present invention provides a theft protection chair structure for motor vehicles, especially to a chair structure to prevent thieves from entering the driving space.

### BACKGROUND OF THE INVENTION

Conventional motor vehicle theft protection locks may be classified as steering wheel fixing locks and gear fixing locks in accordance with the different parts to be locked. The former, just as its name implies, is mainly to fix the steering wheel, to prevent thieves from controlling the direction of the motor vehicle. And the latter, is to fix the gear lever at neutral gear (N gear) or parking gear (P gear), to prevent thieves from starting the motor vehicle, to achieve the effect of theft protection. However, both the former or the latter, needs locking—manually at the time of parking, and unlocking manually at the time of starting, which is time consuming and complicated. Furthermore, due to frequent locking and unlocking action, the locking part of the steering wheel or the gear are worn out, which results in failure of closely locking the locking part with the lock in the best locking state and so negates the theft protection effect.

FIG. 1 to FIG. 3 are schematic views illustrating a conventional motor vehicle chair. The conventional motor vehicle chair is composed of a chair seat 10 and a chair back 11. According to the drivers' posture and driving habit, the chair seat 10 is generally designed to be moveable forward or backwards toward the steering wheel, and the chair back 11 is designed to rotate about the chair seat 10, so as to adjust the driving space to fit every driver's posture and driving habit thereby making the driver comfortable to avoid or reduce tiredness.

Furthermore, the structure to move the chair seat 10 forward or backward, is mostly formed by adding a pair of guide rails 101 under the driver chair. The guide rails 101 are parallel to each other whereby the chair seat 10 can slide along the guide rails 101 thereby adjusting the driver chair forward or backward. The underside end of the chair back 11 is pivotally connected to the back of the chair seat 10 (not shown). The driver can adjust or fix the slant angle between the chair back 11 and the chair seat 10 through a slant angle adjustment device.

Conventional angular adjustment devices generally have two kinds of adjustment structures. The first adjustment structure (as illustrated in FIG. 2), commonly named as the Ferris wheel structure, is mostly comprised of a first gear 102 and a second gear 111 gearing into each other. The first gear 102 is pivotally connected to the inside of the chair seat 10. At one side of the first gear 102, a manual Ferris wheel 103 is mounted outside the chair seat 10, to enable the driver to rotate the first gear 102 by hand. Moreover, an axial region A is mounted through the center of the second gear 111. The axial A is at the underside of the chair back 11. The second gear 111 gears into the first gear 102, to control the slant angle between the chair back 11 and chair seat 10, and to enable the driver to adjust the slant angle of the chair back 11 by controlling the manual Ferris wheel 103.

The second adjustment structure (as illustrated in FIG. 3), generally is named as raising structure. Compared to the above said Ferris wheel adjustment structure, the second gear 111 is pivotally connected to the axial region A, and mounted to the chair back 11, and a raising handle replaces the first gear 102, to limit the rotation of the second gear 111. The raising handle includes a handle 20, which is pivotally connected to the chair seat 10. The front end 21 of the handle 20 extends out the side of the chair seat 10, and the backend of the handle 20 is mounted where at least one gear forms a bulge 22, to limit the angle of the second gear. When the handle 20 is in the fixed state (i.e. state without suffering a force) (as illustrated in FIG. 3), the gear form bulge 22 at the backend of the handle 20 gears into the teeth of the second gear 111, to secure the chair back 11 at a fixing angle. When the handle 20 is in the released state, the gear form 22 at the backend of the handle 20 retreats from the teeth of gear 111, to place the chair back 11 in a free state, thereby enabling the driver to adjust the slant angle of the chair back 11.

Accordingly, the object of the present invention is to use the characteristics of the vehicle driver chair of being able to move forward and backwards and adjust the slant angle, to enable the driver chair to prevent thieves from entering the driving space, so as to provide a theft protection function.

### SUMMARY OF THE INVENTION

The object of the present invention is to provide a theft protection chair structure for motor vehicles which prevents thieves from entering the driving space through a structure enabling to minimize the driving space, thereby providing the theft protection effect.

Another object of the present invention is to provide a theft protection chair structure for motor vehicles, which easily achieves the best theft protection effect without using additional locks through a chair structure to prevent thieves from entering the driving space.

To achieve the above said objects, the present invention provides a theft protection chair structure for motor vehicles, to minimize the driving space for the driver. The theft protection chair structure includes a steering wheel, an accelerator pedal and a brake pedal at the front end of the driving space. The chair structure includes: a chair having a chair seat and a chair back pivotally connected to the chair seat, a chair driving structure driving the chair to move forward or backwards toward the driving space, forming a theft protection state or a sitting state, and an angular adjustment device, to adjust the slant angle between the chair back and chair seat. When the chair driving structure is in a theft protection state, the chair seat is horizontally moved to a front end position, to minimize the distance between the front end of the chair seat and the control pedals in the driving space. When the chair driving structure is in a sitting state, the chair seat is horizontally moved to the backend position, to keep a proper distance between the front end of the chair seat and the control pedals, forming a driving space for the drivers. When the chair driving structure is in a sitting state, the angular adjustment device enables the angle between the chair back and the chair seat to be a right angle or an obtuse angle. When the chair driving structure is in a theft protection state, the angular adjustment device enables the angle between the chair back and chair seat to be at an acute angle, and then locks the chair at the angle. Thus, via the angular adjustment device and the chair driving structure, the driving space is reduced, to provide a theft protection effect.

### BRIEF DESCRIPTION OF THE DRAWINGS

FIG. 1 is a schematic view illustrating a conventional motor vehicle chair.

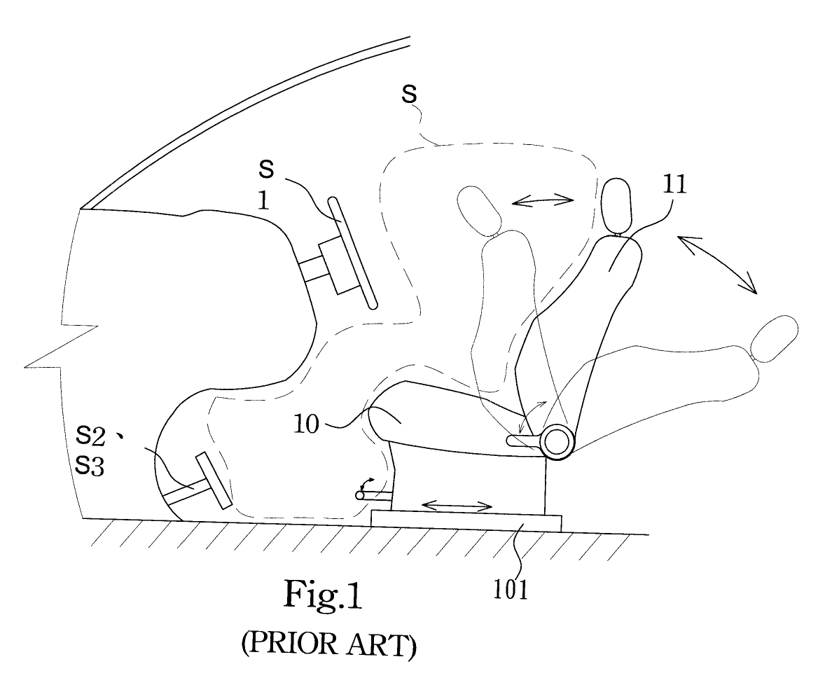

FIG. 2 is a schematic view illustrating a Ferris wheel structure of the conventional motor vehicle chair.

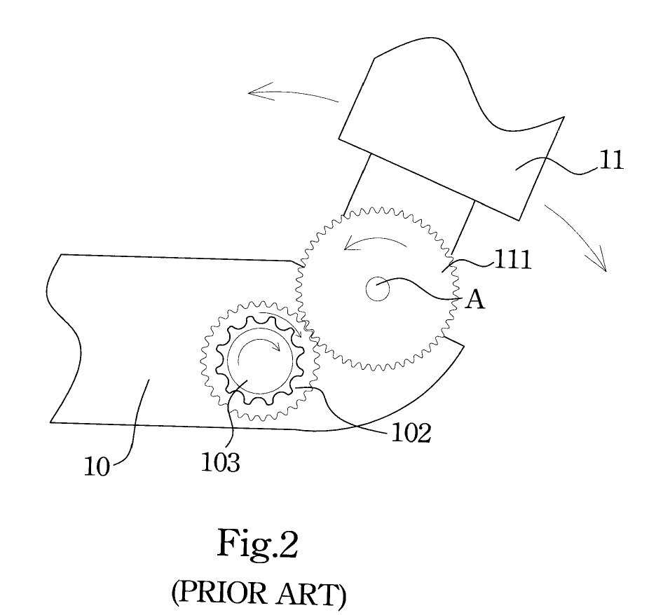

FIG. 3 is a schematic view illustrating a raising structure of the conventional motor vehicle chair.

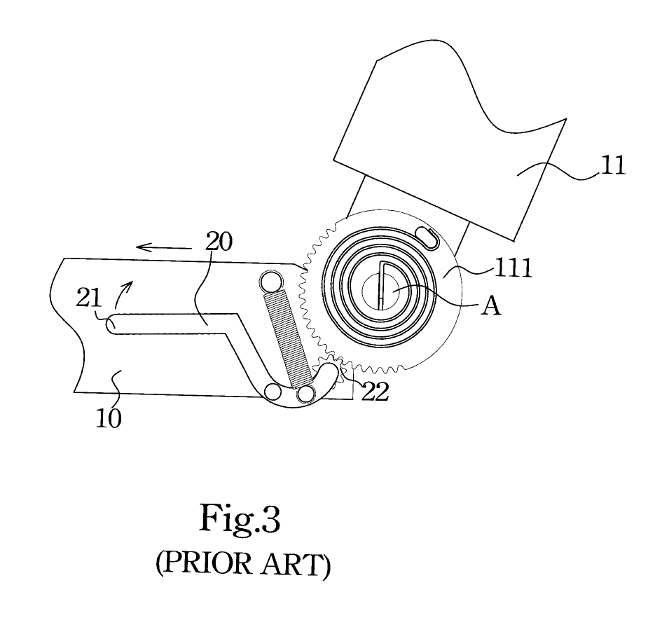

FIG. 4 is a schematic view illustrating the driving space of the theft protection chair structure for motor vehicles of the present invention, wherein the chair is in a theft protection state.

FIG. 5 is a schematic view illustrating the chair driving structure of the theft protection chair structure for motor vehicles of the present invention.

FIG. 6 is a schematic view illustrating the angular adjustment device of the theft protection chair structure for motor vehicles in accordance with an embodiment of the present invention.

FIG. 7 is a schematic view illustrating the motion of the angular adjustment device in FIG. 6.

FIG. 8 is a schematic view illustrating the angular adjustment device in accordance with another embodiment of the present invention.

### DETAILED DESCRIPTION OF THE PREFERRED EMBODIMENT

Referring to the above said object, a preferred embodiment and the schematic views thereof are described herein to illustrate the technical means and the function of the present invention.

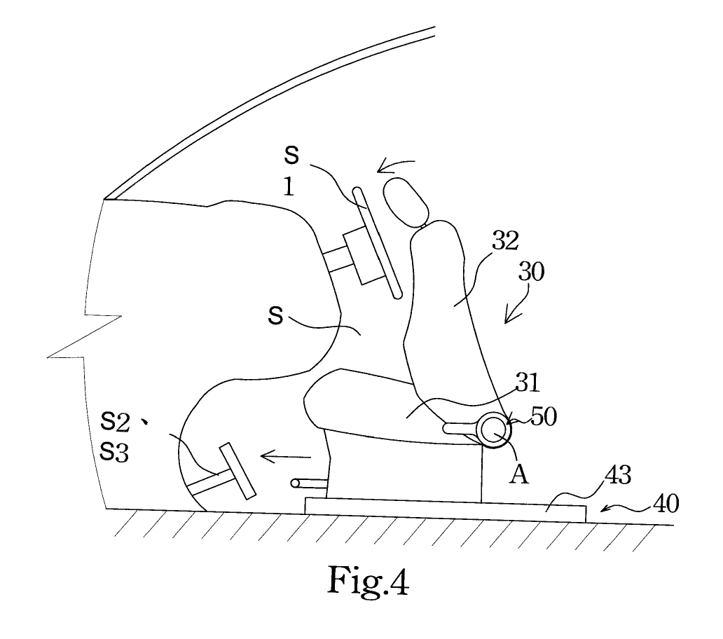

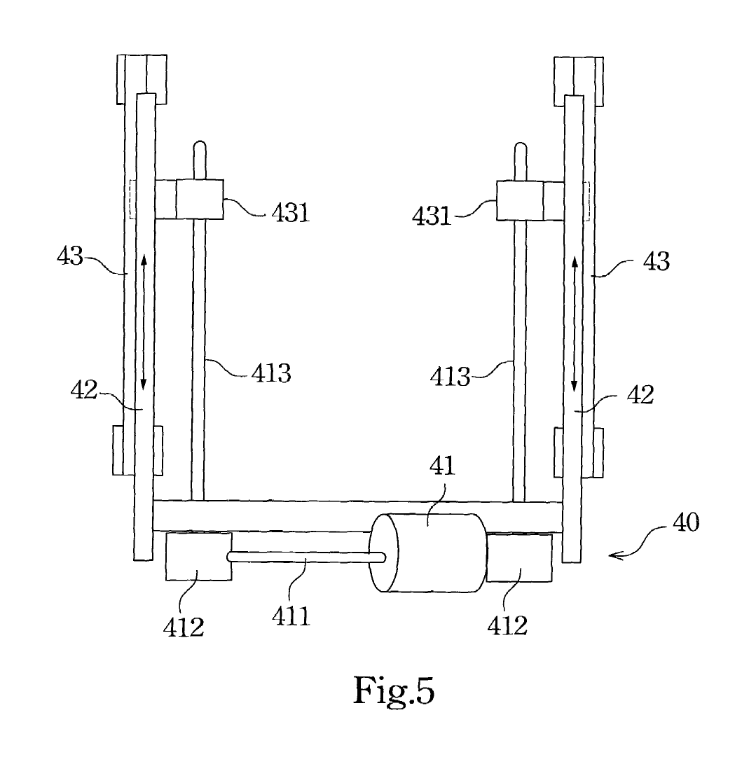

Refer to FIG. 4 and FIG. 5. FIG. 4 is a schematic view illustrating the driving space of a theft protection chair structure for motor vehicles of the present invention, wherein the chair is in theft protection state. FIG. 5 is a schematic view illustrating the chair driving structure of the theft protection chair structure for motor vehicles of the present invention.

As shown in the schematic view, the present invention provides a theft protection chair structure for motor vehicles, to minimize the driving space S for the driver, to prevent thieves from entering the driving space, to provide theft protection effect. A steering wheel S1, an accelerator pedal S2 and a brake pedal S3 are disposed at the front end of the driving space S.

The theft protection chair structure for motor vehicles of the present invention includes a chair 30, a chair driving structure 40 and an angular adjustment device 50. The chair 30 has a chair seat 31 and chair back 32. The under side of the chair back 32 is similar to the conventional chair. The chair back 32 is pivotally connected to the backend of chair seat 31 at an axial region A.

The chair driving structure 40 moves the chair 30 forward or backwards toward the driving space S. In the present embodiment, the chair driving structure 40 includes a driving motor 41 to provide power, a pair of top guide rails 42 mounted to the bottom of the chair 30 and a pair of underside guide rails 43 to guide the moving direction of the chair 30. The underside guide rails 43 are mounted on the bottom board of the motor vehicle body (not shown) of the driving space, and the pair of the underside guide rails 43 each is mounted with a guide block 431. The driving motor 41 is mounted to the chair 30. Each of the two ends of the output axis 411 of the driving motor 41 is separately connected to one screw 413 via a worm gear decelerate box. The screws 413 are screwed through the guide blocks 431. The driving motor 41 can rotate in a positive direction and a negative direction, via the screw thread on the screw 413, to push the top guide rails 42 and the chair 30 to move along the underside guide rails 43 forward and backwards. The front end of the underside guide rails 43 are set towards the position of the pedals S2 and S3 in the driving space S, and the front end is defined as the first position. Correspondingly, the backend of the underside guide rails is defined as the third position; and a second position is between the first and third position. Generally, the distance between the second and the third position is about 220 mm, which is the same as conventional guide rails, and the distance between the first and the second position in the present embodiment is no less than 60 mm. So, when the chair 30 is between the second and the third position of the underside guide rails 43, defining it as a sitting state, the size of the driving space can be adjusted to make the driver to sit comfortably; and when the chair is moved from the second position to the first position, since the distance between the front end of the chair 30 and the pedals of the driving space S is shortest, so it is defined as a theft protection state (as illustrated in FIG. 4). In the theft protection state the driving space S is reduced to minimum, to prevent thieves from entering the driving space, to provide the theft protection effect.

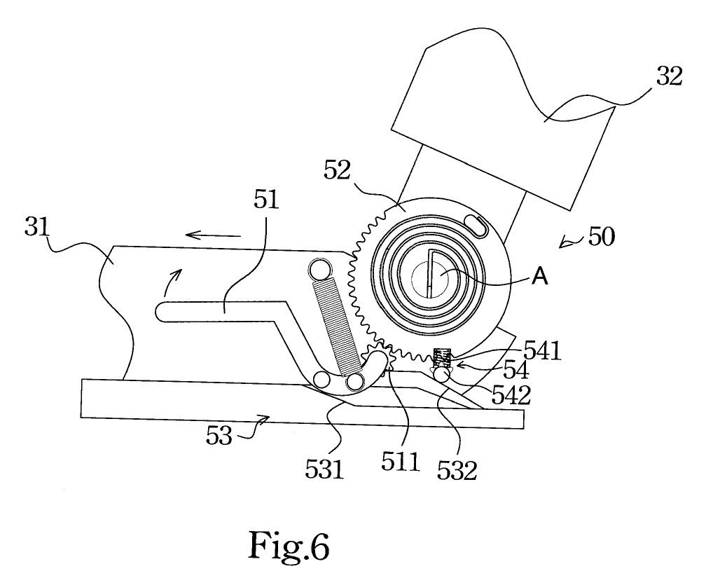

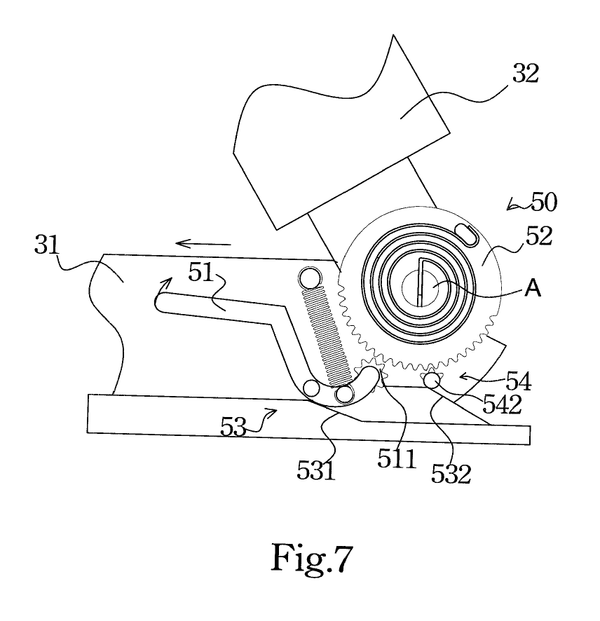

Refer to FIG. 6 and FIG. 7. FIG. 6 is a schematic view illustrating the angular adjustment device in accordance with an embodiment of the present invention; FIG. 7 is a schematic view illustrating the motion of the angular adjustment device in FIG. 6.

The above said angular adjustment device 50, adjusts the slant angle between the chair back 32 and the chair seat 31, in accordance with the state of the chair driving structure 40. The angular adjustment device 50 includes: a handle 51 connected to the chair seat by a pin-jointed structure, a gear 52 mounted to the chair back 32, a meeting and parting structure 53 and a locking structure 54. The front end of the handle 51 is extended out of the chair seat 31, and the backend of the handle is mounted with a gear or a gear form bulge 511. When the handle 51 is in a fixing state to limit the chair back 32, the gear form bulge 511 is inserted into the gear 52, to prevent the gear 52 from rotating, further to fix the slant angle between the chair back 32 and the chair seat 31. When the handle 51 is in the released state, the gear form bulge 511 retreats from the gear 52, so as to adjust the slant angle of the chair back 32. In the released state, the chair back can rotate freely to adjust the slant angle.

When the chair seat 31 is in the theft protection state, the meeting and parting structure 53 controls the chair back 32 to slant, so as to minimize the driving space S. In the present embodiment, the meeting and parting structure 53 at least comprises a first guide bevel 531. The bevel 531 is provided to guide the handle 51 to move from the fixing state to the releasing state. When the chair seat 31 moves from the second position to the first position, the handle 51 is guided by the guide bevel 531, to move from the fixing state to the releasing state. Then the chair back 32 via the elastic force of itself, rotates toward the direction of the front end of the driving space S to minimize the driving space S, so as to prevent thieves from entering the driving space.

The meeting and parting structure 53 further comprises a second guide bevel 532, to guide the locking structure 54. When the locking structure 54 controls the chair back 32 in the theft protection state, it can rotate in only one direction to prevent thieves from rotating the chair back 32 in the opposite direction. The locking structure 54 is mounted at the slot part inside the chair seat 31. The locking structure 54 includes an elastic part 541 and a small gear 542. When the first guide bevel 531 guides the handle 51 to move from the fixing state to the releasing state, the small gear 542 is guided by the second guide bevel 532, to gear into the gear 52. Since the tooth shapes of the small gear 542 and the gear 52 are all ratchet shape, the small gear 542 can effectively limit the chair back 32 to rotate in only one direction, so as to prevent thieves from rotating the chair back 32 in the opposite direction, and to prevent thieves from entering the driving space S, to provide the theft protection effect.

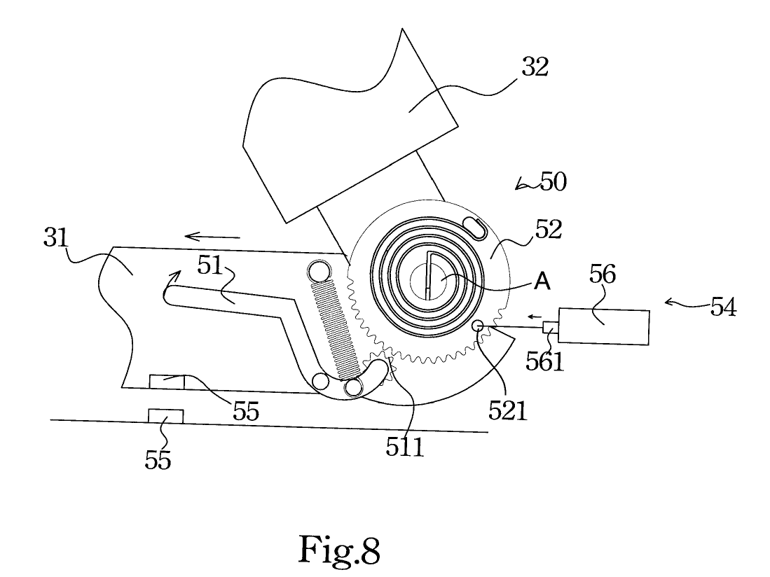

FIG. 8 is a schematic view illustrating the angular adjustment device in accordance with another embodiment of the present invention. The locking structure 54 may include: an inductor 55 and an electromagnetic switch 56 with a bolt 561 on it. When the chair back 32 rotates to a proper theft protection angle, the inductor 55 actives the bolt 561 on the electromagnetic switch 56. The bolt 561 is then inserted in the through hole 521 on the gear 52, to prevent thieves from rotating the chair back 32 in the opposite direction.

In use, it can be combined to the electric theft protection device or center lock of the motor vehicle, to enable the driver to activate the driving motor 41 at the same time of leaving the driving space and locking the door of the motor vehicle. So the driving motor 41 moves the chair seat 31 from the initial position of the underside guide rail 43 between the second and third positions, to the first position of the front end. And at the same time, the handle 51 of the angular adjustment device 50 is guided by the first guide bevel 531, moving from the fixing state to the releasing state. So the chair back 32, via the elastic force of itself rotates toward the direction of the front end of the driving space S, to minimize the driving space S. Then the locking structure 54 locks the chair back 32, to provide the theft protection effect. To cancel the theft protection effect, it is only needed to rotate the driving motor 41 in the opposite direction, to move the chair seat 31 from the first position to the position between the second and the third position of the backend. At the same time, since the handle retreats from the first guide bevel 531, it is reset from the initial releasing state to the fixing state, so as to recover the driving space for the driver to sit in.

Although the present invention has been described in detail with above said preferred embodiments, but it is only to make the people skilled in the art to understand the present invention, not to limit the scope of the invention. So, all the modifications and changes according to the characteristic of shapes or structures and spirit of present invention are involved in the protection scope of the invention.

What is claimed is:

1. A theft protection chair structure for motor vehicles, to minimize the driving space for the driver, a steering wheel, an accelerator pedal and a brake pedal being provided at the front end of the driving space; the theft protection chair structure comprising:
a chair having a chair seat and a chair back connected to the chair seat by a pin-jointed structure;
a chair driving structure for driving the chair forward or backward in the driving space, to form a theft protection state or a sitting state; and
an angular adjustment device for adjusting the slant angle between the chair back and chair seat, wherein when the chair driving structure is in the sitting state, the angular adjustment device enables the angle between the chair back and the chair seat to be a right angle or an obtuse angle; when the chair driving structure is in a theft protection state, the angular adjustment device enables the angle between the chair back and chair seat to be an acute angle, then to be locked and fixed.

2. The theft protection chair structure for motor vehicles of claim 1, wherein the chair driving structure includes:
a pair of underside guide rails mounted on the bottom board of the motor vehicle body, each of the pair of underside guide rails being mounted with a guide block;
a pair of top guide rails mounted to the bottom of the chair; and
a driving motor, wherein the two ends of the output axis of the driving motor are each separately via a worm gear decelerate box connected to a screw, and the screws are screwed through the guide blocks; when the driving motor rotates in positive direction and negative direction, via the screws to push the top guide rails, the chair moves along the underside guide rails forward and backwards.

3. The theft protection chair structure for motor vehicles of claim 1, wherein the angular adjustment device includes:
a gear mounted to the chair back;
a handle connected to the chair seat by a pin-jointed structure, wherein the front end of the handle is extended out of the chair seat, and the backend of the handle is mounted with a gear form bulge according to the teeth of the gear; the handle has a fixing state and a releasing state, when the handle is in a fixing state, the gear form bulge is inserted into the teeth of the gear, and when the handle is in a releasing state, the gear form bulge retreats from the teeth of the gear;
a locking structure for enabling the gear to rotate in single direction; and
a meeting and parting structure for guiding the handle and the locking structure to move.

4. The theft protection chair structure for motor vehicles of claim 2, wherein the angular adjustment device includes:
a gear mounted to the chair back;
a handle connected to the chair seat by a pin-jointed structure, wherein the front end of the handle is extended out of the chair seat, and the backend of the handle is mounted with a gear form bulge according to the teeth of the gear; the handle has a fixing state and a releasing state, when the handle is in a fixing state, the gear form bulge is inserted into the teeth of the gear, and when the handle is in a releasing state, the gear form bulge retreats from the teeth of the gear;
a locking structure for enabling the gear to rotate in single direction; and
a meeting and parting structure for guiding the handle and the locking structure to move.

5. The theft protection chair structure for motor vehicles of claim 3, wherein the locking structure includes an elastic part and a small gear, when the handle is in the fixing state, the small gear retreat from the gear by enduring the elastic force of the elastic part, and when the handle is in a releasing state, the small gear gears into the gear guiding by the meeting and parting structure.

6. The theft protection chair structure for motor vehicles of claim 4, wherein the locking structure includes an elastic part and a small gear, when the handle is in the fixing state, the small gear retreat from the gear by enduring the elastic force of the elastic part, and when the handle is in a releasing state, the small gear gears into the gear guiding by the meeting and parting structure.

7. The theft protection chair structure for motor vehicles of claim 5, wherein the meeting and parting structure includes a first guide bevel to guide the handle to move, and a second guide bevel to guide the small gear to move.

8. The theft protection chair structure for motor vehicles of claim 6, wherein the meeting and parting structure includes a first guide bevel to guide the handle to move, and a second guide bevel to guide the small gear to move.

9. The theft protection chair structure for motor vehicles of claim 5, wherein the tooth shapes of the small gear and the gear are ratchet shape.

10. The theft protection chair structure for motor vehicles of claim 6, wherein the tooth shapes of the small gear and the gear are ratchet shape.

11. The theft protection chair structure for motor vehicles of claim 3, wherein the locking structure includes an inductor and an electromagnetic switch with a bolt thereon, and a through hole defined in the corresponding position of the gear; when the handle is in the fixing state, the bolt retreats from the through hole, and when the handle is in the releasing state, the bolt is inserted into the through hole by the action of the inductor and the electromagnetic switch.

12. The theft protection chair structure for motor vehicles of claim 4, wherein the locking structure includes an inductor and an electromagnetic switch with a bolt thereon, and a through hole defined in the corresponding position of the gear; when the handle is in the fixing state, the bolt retreats from the through hole, and when the handle is in the releasing state, the bolt is inserted into the through hole by the action of the inductor and the electromagnetic switch.
